(19) United States
(12) Patent Application Publication
(10) Pub. No.: US 2008/0001490 A1
(43) Pub. Date: Jan. 3, 2008

(54) DEVICE FOR ACTUATING AN ADJUSTING OR SHIFTING ELEMENT

(75) Inventors: Karl-Hermann Ketteler, Markdorf (DE); Jan Weule, Duisburg (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 11/768,985

(22) Filed: Jun. 27, 2007

(30) Foreign Application Priority Data
Jun. 29, 2006 (DE) 10 2006 030 032.7

(51) Int. Cl. H02K 7/06; H02K 7/10

(52) U.S. Cl. 310/80; 310/83

(57) ABSTRACT

A device having an adjusting drive and a transfer element. The adjusting drive includes a stator and a rotor. The transfer element converts rotational motion to translational motion. The stator is axially longer than the rotor which axially slides within the stator. The difference in length approximately corresponds to the extent of desired axial movement of the rotor. Thus the rotor is provided with a constant electromagnetic torque over the length of axial movement of the rotor. The transfer element, located within the rotor, has a nut/screw connection, which converts torque into an axial adjusting force. A gap, between the stator and rotor, has a size relating to the desired electromagnetic properties of the motor and acts as a bearing during axial movement of the rotor, thus reducing the number of parts needed for the device parts, the amount of wear and favorable production costs when compared with conventional solutions.

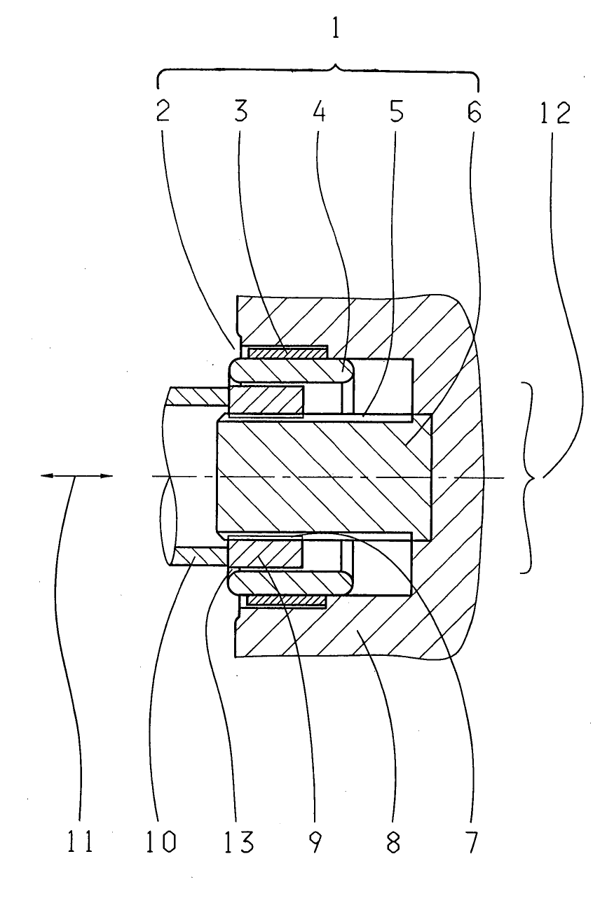

This application claims priority from German Application Serial No. 10 2006 030 032.7 filed Jun. 29, 2006.

### FIELD OF THE INVENTION

This invention relates to a device for actuating an adjusting or shifting element.

### BACKGROUND OF THE INVENTION

In automated transmission devices for actuating shifting elements mostly have one adjusting drive and one transfer element by which a torque, produced by the adjusting drive, is converted to an adjusting force. There control of the engagement and disengagement of a clutch, a brake or of any other shifting element is made possible.

DE 1 253 804 describes one such device with an adjusting drive having one sliding armature motor with a rotor shaft which projects out from both ends of the motor housing and, on one end is provided with a threaded bushing. The threaded bushing acts together with a longitudinally movable, non-rotatably disposed nut situated between two elements which yield when a pre-adjusted pressure of the motor shaft is exceeded. The nut is also provided with a contact element which moves between two contact points that control the motor. In the device described, the threaded bushing and the nut of the transfer element are situated axially next to the drive mechanism. Because of this arrangement, the construction cannot be produced either compact or at reasonable cost on account of the many parts.

In the Applicant's unpublished DE 10 2004 045 432, several adjusting devices are described. All are provided with an adjusting drive and a separate transfer element. The transfer element can be designed in different manners, one being the operating principle used in DE 1 253 804 of a nut/screw connection where, between the rotor of the adjusting drive and the spindle of the power transfer element, a firm connection results. The spindle of the transfer element carries out the lifting motion and must be, accordingly, supported with a low-friction bearing in the motor housing. The adjusting drive and the transfer element are situated axially in succession and, therefore, also demand much axial length.

Other alternatives are known, for example from DE 103 61 127, where the adjusting drive and the transfer element are disposed axially side-by-side. This solution also does not result in an altogether small installation space, but changes only the extension of the whole adjusting device.

The described solutions of the prior art have the disadvantage that the installation space of the device is relatively large, thus being problematic because of the limitations of the installation space available now in today's motor vehicles. These solutions show different possibilities for situating the transfer element relative to the drive mechanism. All solutions also having several supports which, in turn, result in increased production costs and poor degree of efficiency due to friction losses.

The basic problem is overcome with the proposed inventive device, having one adjusting drive for actuating an adjusting or shifting element, such as for a motor vehicle, which demands installation space smaller than the systems known at present and, at the same time, is constructed with fewer parts and can thus be produced at less cost with a greater degree of efficiency.

### SUMMARY OF THE INVENTION

The abovementioned problem is solved according to the invention, by a device having one adjusting drive and one transfer element. The adjusting drive consists of at least one stator and one rotor and the transfer element converting a rotational motion to a translational motion. The stator is designed in axial direction significantly longer than the rotor which is axially movably situated within the stator. The difference in length corresponds approximately to the desired axial movement of the rotor. It is thus advantageously possible during the whole axial adjusting path of the rotor that an equally strong electromagnetic torque to be produced, to drive the rotor over the whole axial adjusting path of the rotor. The transfer element, inventively provided within the rotor, has an operating principle similar to a nut/screw connection which converts a torque to an axial adjusting force. The depth of the air gap is selected according to the desired electromagnetic properties of the motor. The air gap is used as a contact-free bearing for the motion in axial direction. The utilization of the air gap as a bearing results in fewer supporting parts than in conventional solutions and, moreover, in less wear and more favorable cost of production.

The transfer element consists of two parts, namely one outer part and one inner part. The outer part is non-rotatably connected with the motor and the inner part is situated stationarily relative to the stator.

Alternatively, the outer part is designed as an integral component of the rotor such as an inner thread on the rotor. The solution results in advantages by having fewer number of parts and a more favorable production.

The inner part of the transfer element is advantageously designed as a carrier for the rotor. The rotor is thus supported by way of a nut/screw connection on the inner part of the transfer element. Bearings, such as those known from the prior art, can be eliminated. Less friction losses in bearings and more favorable production costs are thus achieved.

When activating the adjusting drive, a torque is produced in the rotor and also introduced in the outer part of the transfer element so that a rotational motion of the rotor produces a simultaneous rotational motion of the outer part of the transfer element. By a nut/screw connection, for example between the inner and outer parts of the transfer element the same as by the stationary arrangement of the inner part, rotational motion of the outer part directly produces a translational motion of the rotor where an adjusting or shifting element connected with the rotor can be actuated, for example.

The outer part of the transfer element or the rotor itself is designed as a spindle nut and the inner part as a threaded spindle. A design with a trapezoidal thread shape is advantageous so that the thread becomes self-locking after disconnection of the adjusting drive. The transfer element can also be designed, for example, as a ball circulating spindle or consist of a planetary rolling thread or a worm lifting transmission or a rolling threaded drive.

Fields of use of the inventive device are the precise regulation of clutches, brakes or synchronizer rings in a transmission. Possible is also utilization in the adjustment of running gear components in an active running gear for a motor vehicle.

An electric motor of the instant type is advantageously insensitive to oil spray where it can be used within a vehicle transmission.

Compared to known solutions, the design requires a smaller installation space such as the installation space, existing at present, in motor vehicles.

The whole actuation system in the clutch inner space can be accommodated without axial enlargement of the installation space. In addition, the axial lift of the synchronizer rings in a vehicle transmission with the adjusting drive can be produced directly on the transmission shaft in the inner space of the transmission and more compact transmission brakes can be produced, such that the arrangements in the clutch or transmission inner space can result in spare installation space.

By way of the good adjustability of electric motors and the lacking elasticity resulting from fewer parts and slight play in the actuator chain, it is possible with more accuracy to regulate clutches, brakes and synchronizer rings in a transmission.

The construction provided is also of more favorable cost since fewer parts are needed, savings in electric consumption are, likewise, obtained by the low friction losses and the design needs few supporting parts.

### BRIEF DESCRIPTION OF THE DRAWINGS

The invention will now be described, by way of example, with reference to the accompanying drawings in which:

A single FIGURE shows a section through an inventive device.

### DETAILED DESCRIPTION OF THE INVENTION

The device 1 essentially comprises of one adjusting drive and one transfer element 12. The adjusting drive comprises at least one rotor 9 and one stator 2 with plates 3 and windings 4. The stator 2 is fastened in a housing 8 and has larger axial length than the rotor 9. One air gap 13 separates the stator 2 and the rotor 9 from one another. The air gap 13 works as a contact-free bearing for the translational motion of the rotor. Upon the inner side of the rotor 9 and upon the outer side of a spindle 6, outer and inner threads 5, 7 are formed. The rotor 9 is non-rotatably mounted on the spindle 6, which is fastened to the housing 8, and by the outer and inner threads 5, 7 is carried by the spindle 6. Alternatively, the rotor 9 is made with a spindle nut and supported by the spindle nut upon the spindle 6. When an electromagnetic torque acts upon the rotor 9, such that rotor 9 will rotate and by way of the outer and inner threads 5, 7 of the rotor 9 and the spindle 6, the rotary motion of the rotor 9 is converted to a translational motion of the rotor 9. By an actuation element 10, fastened on the rotor 9, the translational motion is relayed to an adjusting or shifting element 11, such as a clutch (not shown).

### REFERENCE NUMERALS

1 device
2 stator
3 stator plate
4 stator winding
5 outer thread
6 spindle/inner part of the transfer element
7 inner thread
8 housing
9 rotor/outer part of transfer element
10 actuation element
11 adjusting or shifting element
12 transfer element
13 air gap

1-7. (canceled)

8. A device for actuating at least one of an adjusting and a shifting element of a vehicle transmission, the device comprising:
an electric adjusting drive with at least one stator (2),
a rotor (9); and
a transfer element (12) for converting a rotation motion to a translational motion,
the rotor (9) is axially movably supported relative to the stator (2), the stator (2) having an axial length larger than an axial length of the rotor (9), and the transfer element (12) is located radially within the rotor (9).

9. The device according to claim 8, wherein the transfer element (12) includes an outer part (9) and an inner part (6), the outer part (9) is non-rotatably connected with the inner part (6) and the inner part (6) is situated stationary relative to the stator (2)

10. The device according to claim 9, wherein the outer part (9) of the transfer element (12) has an inner thread (7).

11. The device according to claim 9, wherein the inner part (6) of the transfer element (12) is a carrier for the rotor (9).

12. The device according to claim 9, wherein the outer part (9) is a spindle nut and the inner part (6) is a threaded spindle with a trapezoidal thread.

13. The device according to claim 8, wherein the transfer element (12) is one of a ball rolling spindle, a nut/screw connection, a planetary rolling thread, a worm drive transmission and a following thread drive.

14. The device according to claim 8, wherein the device (1) one of actuates a clutch adjuster or a shifting element (11) of the vehicle transmission and adjusts running gear components of an actively running gear of a motor vehicle.

15. A device for actuating at least one of an adjusting and a shifting element in a vehicle transmission, the device comprising:
a stator (2) being fixed to a housing (8) by a stator plate (3) and having windings (4) extending over an axial length to apply an electromagnetic rotational force;
a rotor (9), located coaxially within the stator (2), being rotationally fixed and axially slidable in relation to the stator (2) and having an axial length shorter than the axial length of the stator (2), the rotor (9) further has interior threads (7); and
a spindle (6) being fixed to the housing (3) and extending coaxially within the rotor (9), the fixed spindle (6) having exterior threads which engage the interior threads of the axially slidable rotor (9), such that when the electromagnetic rotational torque is applied by the stator (2), the rotor (9) slides axially relative to both the stator (2) and the spindle (6).
